(19) United States
(12) Patent Application Publication
(10) Pub. No.: US 2005/0162017 A1
(43) Pub. Date: Jul. 28, 2005

(54) Power supply device for peripheral device

(76) Inventors: Li-Chun Chin, Taoyuan Hsien (TW); Yu-Wen Hsiao, Taoyuan Hsien (TW)

Correspondence Address: BACON & THOMAS, PLLC, 625 SLATERS LANE, FOURTH FLOOR, ALEXANDRIA, VA, 22314, US

(21) Appl. No.: 10/760,345

(22) Filed: Jan. 21, 2004

(51) Int. Cl. H02J 1/10

(52) U.S. Cl. 307/44

(57) ABSTRACT

The present invention is to provide a power supply device for a peripheral device, wherein a power input port of the power supply device is connected to a computer in order to supply power to a charging circuit of the power supply device for charging a rechargeable battery installed therein. When a power output port of the power supply device is connected to the peripheral device, the power supply device will enable an automatic switch assembly thereof to turn on a output switch and supply power from the computer to the peripheral device and enable the rechargeable battery to supply additional power to the peripheral device for compensating the inadequate power supplied by the computer and enabling the peripheral device to be operated in a normal condition.

### FIELD OF THE INVENTION

The present invention relates to power supply and more particularly to an improved power supply device for supplying sufficient power to a peripheral device.

### BACKGROUND OF THE INVENTION

Conventionally, a USB (Universal Serial Bus) port of a computer is adapted to couple to one of a plurality of peripheral devices (e.g., a speaker, a modem, a hard disk drive, a CD-ROM drive, a floppy disk drive, etc.), thereby electrically connecting a motherboard of the computer to the peripheral device. Also, a CPU (central processing unit) on the motherboard is communicatively connected to the peripheral device for transmitting signal or vice versa. Further, two power pins and two data pins are provided on the USB port in which the power pins are electrically connected to a power circuit of the motherboard so that power can be supplied to the peripheral device via the power pins when the peripheral device is connected to the USB port.

However, only a small current (e.g., 5V 400 mA) is supplied from the USB port of the computer to the peripheral device for operation. Such small current, far less than the required power of 5V 1A, is not able to activate the peripheral device. For solving the problem, an additional adaptor is required to couple to the peripheral device for supplying sufficient power thereto. This is very inconvenient since a user has to find an outlet and plug a plug of the adaptor into the outlet prior to converting AC (alternating current) from an external power source into DC (direct current) in the adaptor and supplying DC to the peripheral device. Otherwise, the user is not able to use the peripheral device due to lack of sufficient power. For a portable computer (e.g., notebook computer), this problem is even serious since it is very difficult of finding an I external power source in an outdoor environment. Hence, a need for improvement exists.

### SUMMARY OF THE INVENTION

An object of the present invention is to provide a power supply device for a peripheral device, comprising an automatic switch assembly connected to a power input port and a power output port of the device respectively. The power supply device further comprises a charging circuit connected to the power input port and a rechargeable battery of the device respectively. The rechargeable battery is connected to an output switch of the device. The output switch is connected to the power output port and the automatic switch assembly respectively. Whereby connecting the power input port to a computer will supply power from the computer to the charging circuit for charging the rechargeable battery. Hence, connecting the power output port to the peripheral device will enable the automatic switch assembly to turn the output switch on for supplying power from the computer to the peripheral device and enable the rechargeable battery to supply additional power to the peripheral device for compensating the inadequate power supplied by the computer and enabling the peripheral device to be operated in a normal condition. By utilizing the present invention, the above drawback of supplying insufficient power from a USB port of a computer to a peripheral device for operation will then be overcome.

Another object of the present invention is that in a case of the power input port of the power supply device disconnected from the computer, the automatic switch assembly is adapted to turn off both itself and the output switch in response to detecting reverse current from the peripheral device. As an end, the reverse current will not flow to the rechargeable battery for charging and protection of the rechargeable battery.

Still another object of the present invention is that the power supply device further comprises a battery voltage detector connected to the rechargeable battery, and a battery voltage low indicator connected to the battery voltage detector. Responsive to detecting an operating voltage of the rechargeable battery being too low by the battery voltage detector, the battery voltage detector lights up the battery voltage low indicator as warning that the battery voltage detector is unable to supply sufficient power. Hence, a user may not connect the peripheral device to the power supply device.

A further object of the present invention is that the power supply device further comprises a battery protector disposed between the rechargeable battery and the charging circuit and between the rechargeable battery and the output switch. The battery protector is connected to the rechargeable battery, the output switch, and the charging circuit respectively. The battery protector is adapted to detect both an input current and an output current of the rechargeable battery so that in response to the input or the output current of the rechargeable battery being too large, the battery protector cuts off the circuit for disconnecting the rechargeable battery from the circuit as protection of the rechargeable battery for preventing the rechargeable battery from being damaged.

The above and other objects, features and advantages of the present invention will become apparent from the following detailed description taken with the accompanying drawings.

### BRIEF DESCRIPTION OF THE DRAWINGS

FIG. 1 is an electrical block diagram of a first preferred embodiment of the invention; and

FIG. 2 is an electrical block diagram of a second preferred embodiment of the invention.

### DETAILED DESCRIPTION OF THE PREFERRED EMBODIMENTS

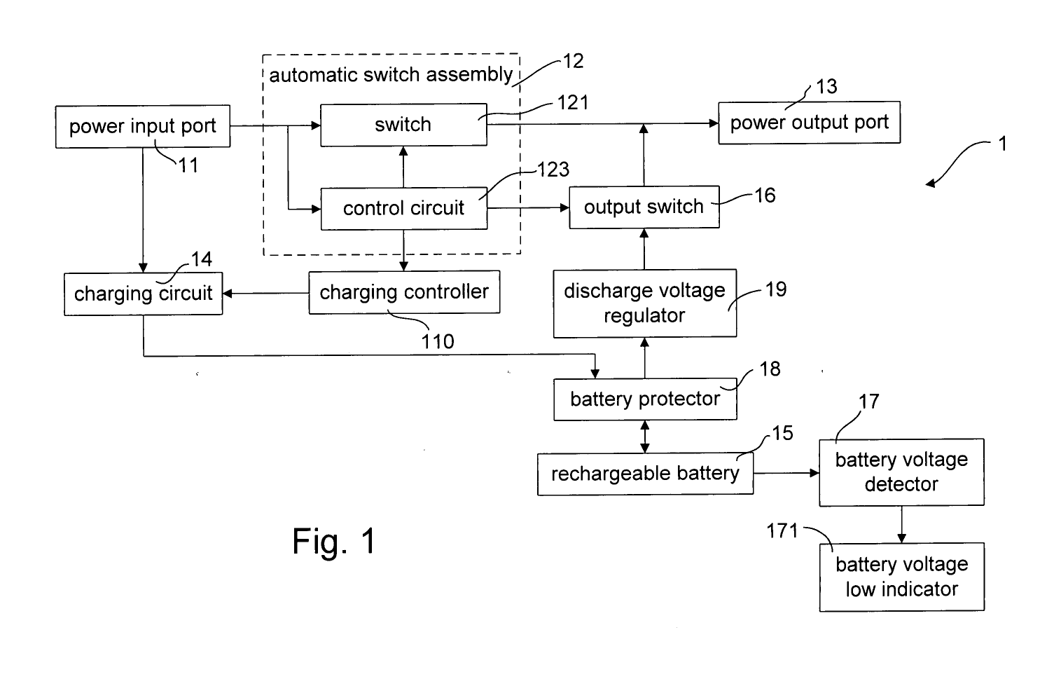

Referring to FIG. 1, there is shown a power supply device 1 for a peripheral device in accordance with a first preferred embodiment of the invention. The power supply device 1 comprises a power input port 11 connected to a computer (e.g., desktop computer, notebook computer, etc.), an automatic switch assembly 12, a power output port 13 connected to a peripheral device (e.g., a speaker, a modem, a hard disk drive, a CD-ROM drive, a floppy disk drive, etc.), a charging circuit 14, a rechargeable battery 15 (implemented as a lithium battery in the embodiment but may be replaced by another suitable element in any other embodiments), and an output switch 16. The power input port 11 is connected to the automatic switch assembly 12. The automatic switch assembly 12 is connected to the power output port 13. When the automatic switch assembly 12 is closed (i.e., on), the power input port 11 is electrically connected to the power output port 13. The charging circuit 14 is connected to the power input port 11. The charging circuit 14 is connected to the rechargeable battery 15. The rechargeable battery 15 is connected to the output switch 16. The output switch 16 is connected to the power output port 13 and the automatic switch assembly 12 respectively. When the power input port 11 is connected to a port (not shown) of a computer, power supplied by the computer will be fed to the charging circuit 14 which in turn charges the rechargeable battery 15.

By configuring as above, in a case of the power output port 13 connected to a peripheral device (not shown), the automatic switch assembly 12 is able to detect signal output from the peripheral device for controlling and then turn the output switch 16 on. As such, power of the computer can be supplied to the peripheral device via the power input port 11, the automatic switch assembly 12, and the power output port 13 sequentially. At the same time, the rechargeable battery 15 will supply additional power to the peripheral device as a compensation for the inadequate power supplied by the computer. As a result, the peripheral device can operate normally due to sufficient power supply.

Referring to FIG. 1 again, the automatic switch assembly 12 comprises a switch 121 and a control circuit 123. The switch 121 is connected to the power input port 11. The switch 121 is also connected to the power output port 13. The control circuit 123 is connected to the switch 121, the power input port 11, and the output switch 16 respectively. In a case of the control circuit 123 detected signal output from the peripheral device, the control circuit 123 controls the switch 121 and is aware that the output switch 16 is on. As such, power of the computer can be supplied to the peripheral device via the power input port 11, the switch 121, and the power output port 13 sequentially. At the same time, the rechargeable battery 15 will supply additional power to the peripheral device as a compensation for the inadequate power supplied by the computer. As a result, the peripheral device can operate normally due to sufficient power supply.

Referring to FIG. 1 again, in the embodiment in a case of the power input port 11 of the power supply device 1 disconnected from the computer, the control circuit 123 of the automatic switch assembly 12 is adapted to open both the switch 121 and the output switch 16 (i.e., off) in response to detecting reverse current from the peripheral device. As an end, the reverse current will not flow to the rechargeable battery 15 for charging. This is a protection arrangement of the rechargeable battery 15.

Referring to FIG. 1 again, the power supply device 1 further comprises a battery voltage detector 17 connected to the rechargeable battery 15, and a battery voltage low indicator 171 connected to the battery voltage detector 17. When the battery voltage detector 17 detects that the operating voltage of the rechargeable battery 15 is too low, the battery voltage detector 17 lights up the battery voltage low indicator 171 as warning so that a user can be aware that the battery voltage detector 15 is unable to supply sufficient power. Hence, the user may not connect the peripheral device to the power supply device 1.

Referring to FIG. 1 again, there is provided a battery protector 18 between the rechargeable battery 15 and the charging circuit 14 and between the rechargeable battery 15 and the output switch 16. The battery protector 18 is connected to the rechargeable battery 15, the output switch 16, and the charging circuit 14 respectively. The battery protector 18 is adapted to detect both input current and output current of the rechargeable battery 15. When input or output current of the rechargeable battery 15 is too large, the battery protector 18 cuts off the circuit so as to disconnect the rechargeable battery 15 from the circuit. This is a protection arrangement of the rechargeable battery 15 for preventing the rechargeable battery 15 from being damaged.

Referring to FIG. 1 again, there is provided a discharge voltage regulator 19 between the output switch 16 and the battery protector 18. The discharge voltage regulator 19 is connected to the output switch 16 and the battery protector 18 respectively. The discharge voltage regulator 19 is adapted to regulate voltage of output power of the rechargeable battery 15 when the rechargeable battery 15 is supplying power to the peripheral device. As an end, voltage of output power of the rechargeable battery 15 can be converted into one required for operating the peripheral device.

Referring to FIG. 1 again, the power supply device 1 further comprises a charging controller 110 connected to the charging circuit 14. The charging controller 110 is further connected to the control circuit 123 of the automatic switch assembly 12. As such, the control circuit 123 is able to control the charging controller 110 which in turn is adapted to control a charging of the rechargeable battery 15 by the charging circuit 14.

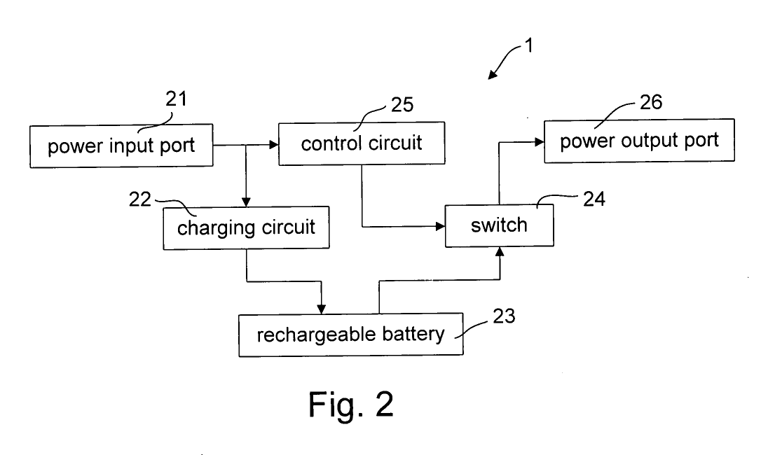

Referring to FIG. 2, there is shown a power supply device 1 in accordance with a second preferred embodiment of the invention. The power supply device 1 comprises a power input port 21, a charging circuit 22, a rechargeable battery 23 (implemented as a lithium battery in the embodiment but may be replaced by another suitable element in any other embodiments), a switch 24, a control circuit 25, and a power output port 26. The power input port 21 is connected to the charging circuit 22. The charging circuit 22 is connected to the rechargeable battery 23. The rechargeable battery 23 is connected to the switch 24. The switch 24 is connected to the power output port 26. The control circuit 25 is connected to the power input port 21. Finally, the control circuit 25 is connected to switch 24.

By configuring as above, in a case of the power input port 21 connected to a port (not shown) of a computer (e.g., desktop computer, notebook computer, etc.) and the power output port 26 connected to a peripheral device (not shown) (e.g., a speaker, a modem, a hard disk drive, a CD-ROM drive, a floppy disk drive, etc.), the control circuit 25 is able to detect power output from the computer for turning on the switch 24. As such, power output from the computer can be supplied to the rechargeable battery 23 via the charging circuit 22. After the rechargeable battery 23 has been charged, the rechargeable battery 23 is able to supply sufficient power to the peripheral device. As a result, the peripheral device can operate normally due to sufficient power supply.

Moreover, in a case of the power input port 21 of the power supply device 1 disconnected from the computer, the control circuit 25 is adapted to open the switch 24 (i.e., off) in response to detecting a reverse current from the peripheral device. As an end, the reverse current will not flow to the rechargeable battery 23 for charging. This is a protection arrangement of the rechargeable battery 23.

While the invention has been described by means of specific embodiments, numerous modifications and variations could be made thereto by those skilled in the art without departing from the scope and spirit of the invention set forth in the claims.

1. A power supply device for a peripheral device, comprising:
a power input port connected to a computer;
an automatic switch assembly connected to the power input port;
a power output port connected to the peripheral device and the automatic switch assembly respectively wherein the power output port is connected to the power input port in response to turning on the automatic switch assembly;
a charging circuit connected to the power input port;
a rechargeable battery connected to the charging circuit; and
an output switch connected to the charging circuit, the power output port, and the automatic switch assembly respectively,
whereby connecting the power output port to the peripheral device will enable the automatic switch assembly to detect signal output from the peripheral device for controlling and enable the automatic switch assembly to be aware that the output switch is on, will supply the computer to the peripheral device via the power input port, the automatic switch assembly, and the power output port sequentially, will enable the rechargeable battery to supply additional power to the peripheral device as a compensation for inadequate power supplied by the computer, and will operate the peripheral device normally.

2. The power supply device of claim 1, wherein the automatic switch assembly comprises a switch connected to the power input port and the power output port respectively, and a control circuit connected to the switch, the power input port, and the output switch respectively so that responsive to detecting signal output from the peripheral device by the control circuit, the control circuit is adapted to control the switch and is aware that the output switch is turned on, power of the computer is adapted to supply to the peripheral device via the power input port, the switch, and the power output port sequentially, the rechargeable battery is adapted to supply additional power to the peripheral device as a compensation for the inadequate power supplied by the computer, and the peripheral device is adapted to operate normally.

3. The power supply device of claim 2, further comprising a battery voltage detector connected to the rechargeable battery, and a battery voltage low indicator connected to the battery voltage detector, wherein responsive to detecting an operating voltage of the rechargeable battery being too low by the battery voltage detector, the battery voltage detector lights up the battery voltage low indicator as warning that the battery voltage detector is unable to supply sufficient power.

4. The power supply device of claim 3, further comprising a battery protector disposed between the rechargeable battery and the charging circuit and between the rechargeable battery and the output switch, wherein the battery protector is connected to the rechargeable battery, the output switch, and the charging circuit respectively, and the battery protector is adapted to detect both an input current and an output current of the rechargeable battery so that in response to the input or the output current of the rechargeable battery being too large, the battery protector cuts off the circuit for disconnecting the rechargeable battery from the circuit as protection of the rechargeable battery for preventing the rechargeable battery from being damaged.

5. The power supply device of claim 4, further comprising a discharge voltage regulator disposed between the output switch and the battery protector, wherein the discharge voltage regulator is connected to the output switch and the battery protector respectively so that the discharge voltage regulator is adapted to regulate voltage of output power of the rechargeable battery when the rechargeable battery is supplying power to the peripheral device, and the voltage of the output power of the rechargeable battery is adapted to convert into one required for operating the peripheral device.

6. The power supply device of claim 5, further comprising a charging controller connected to the charging circuit and the control circuit of the automatic switch assembly respectively, wherein the control circuit is adapted to control the charging controller which in turn is adapted to control charging of the rechargeable battery by the charging circuit.

7. The power supply device of claim 1, wherein the rechargeable battery is a lithium battery.
